(19) United States
(12) Patent Application Publication
(10) Pub. No.: US 2022/0291061 A1
(43) Pub. Date: Sep. 15, 2022

(54) PREPARATION METHOD FOR A FLEXIBLE STRESS SENSOR BASED ON A COMPOSITE MULTILAYER CONDUCTIVE MATERIAL

(71) Applicant: WUYI UNIVERSITY, Jiangmen, Guangdong (CN)

(72) Inventors: Xin HE, Jiangmen, Guangdong (CN); Gengzhe SHEN, Jiangmen, Guangdong (CN); Baihua CHEN, Jiangmen, Guangdong (CN); Weijia YANG, Jiangmen, Guangdong (CN); Tianlong LIANG, Jiangmen, Guangdong (CN); Weiqing HUANG, Jiangmen, Guangdong (CN); Haifeng LI, Jiangmen, Guangdong (CN)

(21) Appl. No.: 17/774,672

(22) PCT Filed: Mar. 28, 2020
(86) PCT No.: PCT/CN2020/081899

§ 371 Date: May 5, 2022

(30) Foreign Application Priority Data
Nov. 8, 2019 (CN) 201911089672.3

(51) Int. Cl. G01L 1/22; D04H 1/728

(52) U.S. Cl. CPC G01L 1/2287; D04H 1/728; D10B 2101/12

(57) ABSTRACT

The invention discloses a preparation method for a flexible stress sensor based on a composite multilayer conductive material. The method comprises the following steps: S1) preparing a PEDOT: PSS cotton cloth fiber layer; S2) preparing conductive carbon cloth; S3) preparing a metal silver nanowire conductive film; S4) preparing a flexible stress sensor, involving: packaging the PEDOT: PSS cotton cloth fiber layer, the disordered conductive carbon cloth and the silver nanowire conductive film together, and respectively leading a wire out of the PEDOT: PSS cotton cloth fiber layer and the silver nanowire conductive film to obtain the flexible stress sensor. The silver nanowire, the conductive carbon cloth and the PEDOT: PSS cotton cloth fiber cooperate with each other with different different conductivities, realizing the richer resistance variability, the wider resistance change range, higher resistance change rate and higher sensing range up to 70 kPa.

### TECHNICAL FIELD

The invention relates to the technical field of sensors, in particular to a preparation method for a flexible stress sensor based on a composite multilayer conductive material.

### BACKGROUND ART

With the rapid development of a new generation of flexible electronic materials and sensing technologies, flexible stress sensors have gradually become an important research object for researchers.

Flexible stress sensors reflect the pairing relationship between physical and electrical signals by converting the physical stimulus signal into an electronic signal. Flexible stress sensors typically comprise two main components: the flexible substrate and the conductive layer material.

Flexible substrates are typically plastic films, such as polydimethylsiloxane, polyethylene terephthalate, polyimide, or polyvinyl chloride, enable the sensor to be equipped with the excellent durability and allow the comfortable attachment to the body. Meanwhile, various advanced materials have been used to prepare conductive layers, such as silver nanowires (AgNW), copper nanowires (CuNW), gold nanowires (AuNWs), carbon nanotubes (CNT), graphene, and conductive polymers. In addition to the utilization of new materials, the construction of sensors with novel microstructures can enhance the properties of flexible sensors. The high compressibility of microstructures allows them to deform even under low pressure. In addition, the microstructure can reduce the influences of viscoelasticity and hysteresis effects of the polymer, thereby improving the response speed.

However, the sensing range of sensors prepared by the above methods is usually relatively narrow (<30 kPa), the conductive layer material of the traditional sensor is relatively single, and the changes of pairing of resistance are not obvious. The microstructure is relatively simple aimed at the response of a microstructure, ignoring the applications of multiple structural pairs. Therefore, there remain a great challenge to manufacture flexible pressure sensors with innovativeness, high sensitivity, wide detection range and long stable life.

### SUMMARY OF THE INVENTION

To solve the above problems in the background of the prior art, the invention intended to provide a preparation method for a flexible stress sensor based on a composite multilayer conductive material, and the flexible resistive stress sensor provided by the invention has the advantages of high sensitivity, wide detection range, and long stable life.

To achieve the above aims, the invention provides a technical solution: a preparation method for a flexible stress sensor based on a composite multilayer conductive material, comprising the following steps:

S1). preparing a PEDOT: PSS cotton cloth fiber layer (1)

S101). adding poly-3,4-ethoxylene dioxy thiophene monomer: polystyrene sulfonate PEDOT:PSS to a dimethyl sulfoxide DMSO solution for modification; heating and stirring in an oil bath at 40-60° C. for 0.5-2 h and dropwise adding absolute ethyl alcohol for 1-3 h to obtain a modified PEDOT:PSS conductive solution.

S102). soaking the cotton cloth fiber sheet with the appropriate size into the modified PEDOT:PSS conductive solution in step S101), and stirring at room temperature for 3-5 h, and then dried at 70-100° C. for 1-3 h.

S103). repeating the step S102) for 2-5 times, until the modified PEDOT:PSS conductive solution evenly penetrated and firmly attached to the cotton cloth fiber plate, to obtain PEDOT: PSS conductive cotton cloth;

S104). laying the PEDOT: PSS conductive cotton cloth obtained in step S103) is on the surface of PDMS solution, to fix up and cover the one side of the conductive cotton cloth with PDMS solution, and to obtain PEDOT: PSS cotton cloth fiber layer;

S2). preparing conductive carbon cloth

S201). under the condition of 40-60% humidity, dissolving polyacrylonitrile PAN in N—N dimethylformamide DMF solvent to configure a solution of 10-20 wt % concentration.

S202). stirring the solution obtained in step S201) at a constant temperature of 50-70° C. for 3-8 h to obtain a spinning solution, and to be sealed and stored for backup.

S203). preparing disordered conductive carbon cloth by disordered electrostatic spinning machine;

S3). preparing a metal silver nanowire conductive film

S301). dissolving a certain amount of glucose, silver nitrate and iron sulfate in deionized water respectively and after mixed together, magnetically stirring for a few minutes to produce a bright yellow solution at room temperature.

S303). leading the polyvinylpyrrolidone PVP into the bright yellow solution in step S301), and stirring the mixture continuously until PVP is completely dissolved, then sealing and heating it at 150-180° C. for 3-8 hours in the high pressure reactor, to obtain a gray-green precipitate after finishing the hot water reaction;

S304). washing the gray-green precipitate obtained in step S303) several times with dilute nitric acid solution to remove the oxide layer on the surface of the nanowires; then adding ethanol to remove excess nitric acid under the action of a centrifuge and collecting the long silver nanowires by repeated filtration.

S305). covering the glass with the long silver nanowires obtained in step S304) and heating it at a temperature of 200-300° C. for 2-3 h, then solidifying it with PDMS at 60-100° C. for 2-6 h and peeling it off to obtain a silver nanowire conductive film.

S4). preparing a flexible stress sensor

S401). packaging the PEDOT:PSS cotton cloth fiber layer prepared in step S1), the disordered conductive carbon cloth prepared in step S2), and the silver nanowire conductive film prepared in step S3) together; packaging the edges by using PDMS and be solidified at 60-100° C. for 0.5-2 h.

S402). leading wires from the PEDOT:PSS cotton cloth fiber layer and the silver nanowire conductive film respectively, to obtain a flexible stress sensor.

Preferably, in step S104) of the above method, the resistance of the obtained PEDOT:PSS cotton cloth fiber layer is controlled at 900-1200Ω.

Preferably, in step S203) of the above method, the PAN fibers are obtained by disordered electrostatic spinning machine to spin for 8-12 h with the receive distance of 10-15 cm and voltage of 3-5 KV, and then prepared by heating at the temperature of 900-1100° C. for 1-5 h to obtain disordered conductive carbon cloth.

Preferably, in step S203) of the above method, the resistance of the obtained disordered conductive carbon cloth is controlled at 200-300Ω.

Preferably, in step S301) of the above method, the glucose, silver nitrate and iron sulfate are dissolved in deionized water in a volume ratio of 2:2:1.

Preferably, in step S304) of the above method, the long silver nanowires have a length of 10-15 μm and a diameter of 200-300 nm.

Preferably, in step S305) of the above method, the resistance of the obtained silver nanowire conductive film is controlled at 0.1-3Ω.

Preferably, in step S401) of the above method, the PEDOT: PSS cotton cloth fiber layer, disordered conductive carbon cloth, and silver nanowire conductive film are packaged in a sandwich structure, and the disordered conductive carbon cloth is provided between the PEDOT: PSS cotton cloth fiber layer and the silver nanowire conductive film.

Preferably, in step S402) of the above method, the wires are copper conductive tape.

Compared to the prior art, the technical solution has the following technical advantages and beneficial effects:

1. the invention strengthens the conductive channel by soaking PEDOT:PSS in cotton cloth fiber through the fiber as a carrier, and while utilizing the contraction elasticity of the cotton itself to achieve structural strain, thus changing the resistance;

2. the invention prepares disordered conductive carbon cloth by electrostatic spinning, realizing a simple and easy method for mass production in large scale;

3. the invention effectively enhances the adhesion ability of silver nanowires with the PDMS elastic substrate of silver nanowires, to prevent the shedding of silver nanowires during motion and to improve the service life;

4. the invention realizes a network conduction state to achieve the connectivity of the conduction network with the silver nanowires embedded in PDMS;

5. the invention provides the silver nanowire, the conductive carbon cloth (3) and the PEDOT: PSS cotton cloth fiber to cooperate with each other with different different conductivities, realizing the richer resistance variability, the wider resistance change range, higher resistance change rate and higher sensing range up to 70 kPa; achieving the compressible gap at a contact node between layers;

6. the invention provides three flexible multilayer conductive materials, with good bending resistance as well as the good mechanical properties and ability of stretching and pressing, which is suitable for the preparation of flexible sensors and other electronic components.

### BRIEF DESCRIPTION OF ACCOMPANY DRAWINGS

FIG. 1 is a schematic diagram of the structure of the flexible stress sensor provided by the invention.

FIG. 2 is a SEM diagram of the carbon fiber of the conductive carbon cloth provided by the present invention.

FIG. 3 is a SEM diagram of the conductive film of silver nanowires provided by the invention.

FIG. 4 is a diagram of the relationships between the resistance relative change and time of the flexible stress sensor prepared in Embodiment 1 provided by the invention, which starts from 0.5 kPa and increasing sequentially by 0.5 kPa to 2.5 kPa.

In the figures, 1. the PEDOT: PSS cotton cloth fiber layer; 2. the wires; 3. the disordered conductive carbon cloth; 4. the silver nanowire conductive film.

### DESCRIPTION OF EMBODIMENTS

To make the technical solutions provided by the invention more comprehensible, a further description of the invention is given below in combination with the attached drawings and embodiments, and the embodiments are exemplary and not the limitations of the scope of the disclosure.

### Embodiments 1

A preparation method for a flexible stress sensor based on a composite multilayer conductive material, comprises the following steps:

S1). preparing a PEDOT: PSS cotton cloth fiber layer

S101). adding 3 g poly-3,4-ethoxylene dioxy thiophene monomer: polystyrene sulfonate PEDOT:PSS to the 0.45 g dimethyl sulfoxide DMSO solution for modification; heating and stirring in an oil bath at 50° C. for 1 h and dropwise adding 5 mL absolute ethyl alcohol for 2 h with the temperate 50° C. to obtain a modified PEDOT:PSS conductive solution.

S102). soaking the cotton cloth fiber sheet with the size of 1×5 cm into the modified PEDOT:PSS conductive solution in step S101), and stirring at room temperature for 4 h, and then dried at 80° C. for 2 h.

S103). repeating the step S102) for 3 times, until the modified PEDOT:PSS conductive solution evenly penetrated and firmly attached to the cotton cloth fiber plate, to obtain PEDOT: PSS conductive cotton cloth;

S104). laying the PEDOT: PSS conductive cotton cloth obtained in step S103) is on the surface of PDMS solution, to fix up and cover the one side of the conductive cotton cloth with PDMS solution, and to obtain PEDOT: PSS cotton cloth fiber layer; the resistance is controlled at 989Ω.

S2). preparing conductive carbon cloth

S201). under the condition of 50% humidity, dissolving polyacrylonitrile PAN in N—N dimethylformamide DMF solvent to configure a solution of 15 wt % concentration.

S202). stirring the solution obtained in step S201) at a constant temperature of 60° C. for 6 h to obtain a spinning solution, and to be sealed and stored for backup.

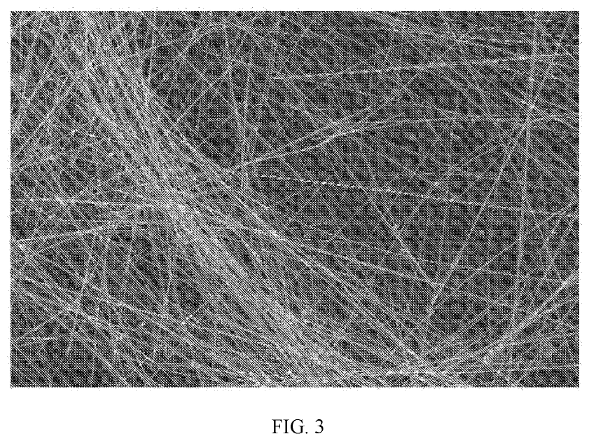

S203). to obtain the PAN fiber through spinning for 12 h by the disorder electrostatic spinning machine with the receiving distance of 10 cm and voltage 4.5 KV, then after the heating of 1000° C. for 2 h to obtain the disorder conductive carbon cloth with the resistance control of 250Ω; the SEM diagram of the carbon fiber of the conductive carbon cloth is shown in FIG. 2.

S3). preparing a metal silver nanowire conductive film

S301). dissolving 2 mmol glucose, 1.5 mmol silver nitrate and 0.3 mmol iron sulfate in deionized water respectively and after mixed together, magnetically stirring for a few minutes to produce a bright yellow solution at room temperature.

S303). leading the 4.5 g polyvinylpyrrolidone PVP into the bright yellow solution in step S301), and stirring the mixture continuously until PVP is completely dissolved, then sealing and heating it at 160° C. for 8 hours in the high pressure reactor, to obtain a gray-green precipitate after finishing the hot water reaction;

S304). washing the gray-green precipitate obtained in step S303) several times with dilute nitric acid solution to remove the oxide layer on the surface of the nanowires; then adding ethanol to remove excess nitric acid under the action of a centrifuge and collecting the long silver nanowires by repeated filtration, as shown in the FIG. 3;

S305). covering the glass of 500 nm with the long silver nanowires obtained in step S304) and heating it at a temperature of 250° C. for 1.5 h, then solidifying it with PDMS at 80° C. for 3 h and peeling it off to obtain a silver nanowire conductive film; the resistance is controlled at 0.5Ω.

S4). preparing a flexible stress sensor

S401). packaging the PEDOT:PSS cotton cloth fiber layer prepared in step S1), the disordered conductive carbon cloth prepared in step S2), and the silver nanowire conductive film prepared in step S3) together to form a 1×1 cm block according to the sandwich structure; packaging the edges by using PDMS and be solidified at 80° C. for 1 h;

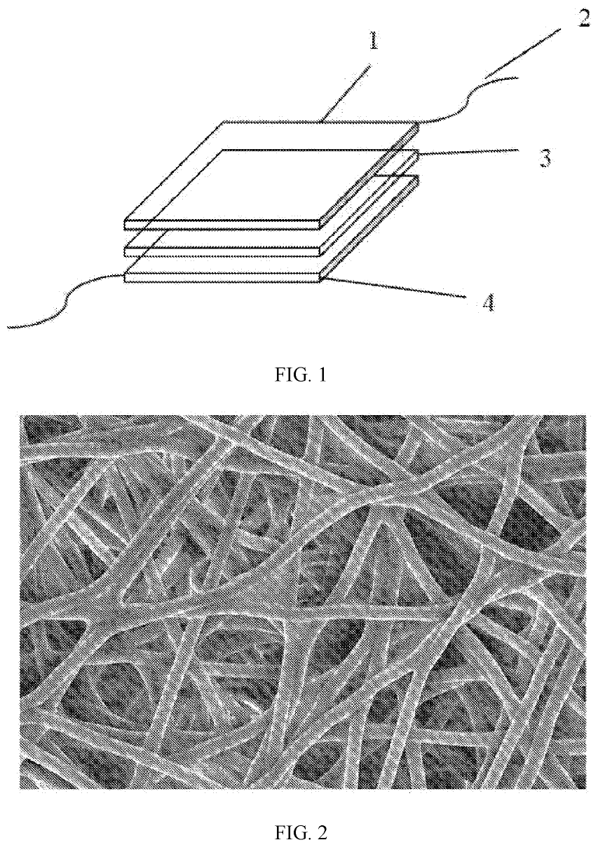

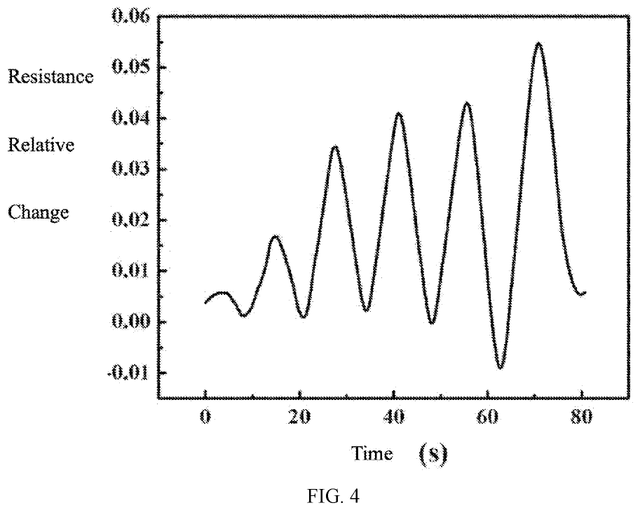

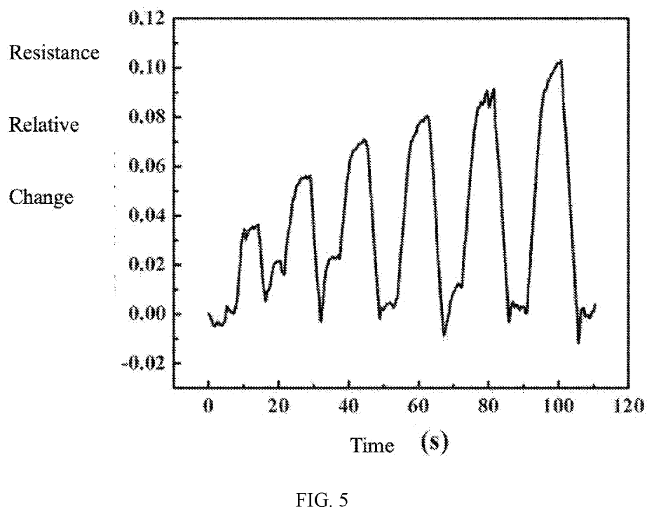

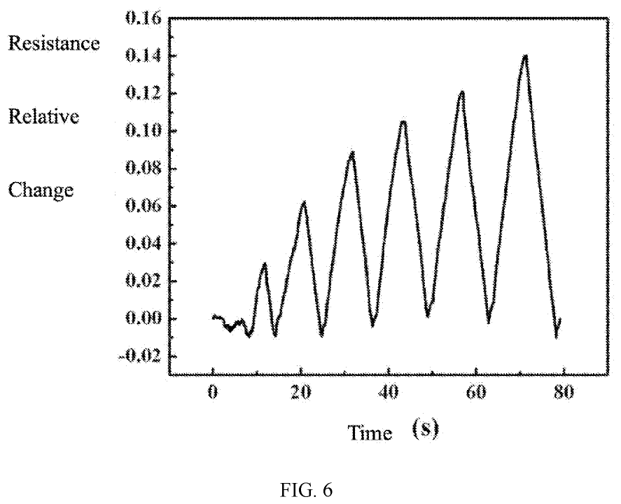

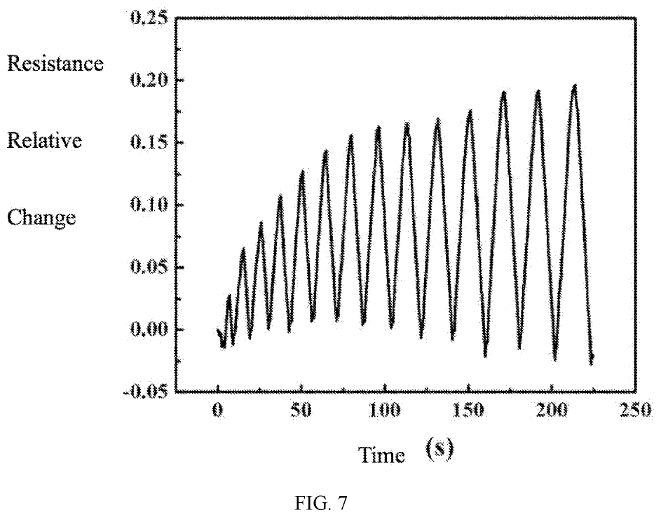

S402). leading wires from the PEDOT:PSS cotton cloth fiber layer and the silver nanowire conductive film respectively, to obtain a flexible stress sensor. As shown in FIG. 1, the sensor comprises the PEDOT: PSS cotton cloth fiber layer 2, disordered conductive carbon cloth 3, and silver nanowire conductive film 4 from top to bottom successively, and the disordered conductive carbon cloth 3 is provided between PEDOT: PSS cotton cloth fiber layer 1 and silver nanowire conductive film 4; the wires 2 are copper conductive tape. The sensor provided by the embodiments starts from 0.5 kPa and increasing sequentially by 0.5 kPa to 2.5 kPa, the diagram of the relationships between the resistance relative change and time of the flexible stress sensor can be shown in FIG. 4. According to the diagram, the sensor will increase in accordance with 0.5 kPa as a gradient increment with the gradual increase of the resistance relative change of the pressure; The relative change of resistance is 0.015 when is 0.5 kPa, the relative change of resistance is 0.035 when 1 kPa, the relative change of resistance is 0.040 when is 1.5 kPa, the relative change of resistance is 0.045 when is 2 kPa, the relative change of resistance is 0.055 when is 2.5 kPa.

### Embodiments 2

A preparation method for a flexible stress sensor based on a composite multilayer conductive material, comprises the following steps:

S1). preparing a PEDOT: PSS cotton cloth fiber layer

S101). adding 2.5 g poly-3,4-ethoxylene dioxy thiophene monomer: polystyrene sulfonate PEDOT:PSS to the 0.35 g dimethyl sulfoxide DMSO solution for modification; heating and stirring in an oil bath at 50° C. for 1 h and dropwise adding 5 mL absolute ethyl alcohol for 2 h with the temperate 50° C. to obtain a modified PEDOT:PSS conductive solution.

S102). soaking the cotton cloth fiber sheet with the size of 1×5 cm into the modified PEDOT:PSS conductive solution in step S101), and stirring at room temperature for 4 h, and then dried at 80° C. for 2 h.

S103). repeating the step S102) for 3 times, until the modified PEDOT:PSS conductive solution evenly penetrated and firmly attached to the cotton cloth fiber plate, to obtain PEDOT: PSS conductive cotton cloth;

S104). laying the PEDOT: PSS conductive cotton cloth obtained in step S103) is on the surface of PDMS solution, to fix up and cover the one side of the conductive cotton cloth with PDMS solution, and to obtain PEDOT: PSS cotton cloth fiber layer; the resistance is controlled at 1012Ω.

S2). preparing conductive carbon cloth

S201). under the condition of 50% humidity, dissolving polyacrylonitrile PAN in N—N dimethylformamide DMF solvent to configure a solution of 15 wt % concentration.

S202). stirring the solution obtained in step S201) at a constant temperature of 60° C. for 6 h to obtain a spinning solution, and to be sealed and stored for backup.

S203). to obtain the PAN fiber through spinning for 12 h by the disorder electrostatic spinning machine with the receiving distance of 10 cm and voltage 4.5 KV, then after the heating of 1000° C. for 2 h to obtain the disorder conductive carbon cloth with the resistance control of 200Ω;

S3). preparing a metal silver nanowire conductive film

S301). dissolving 2 mmol glucose, 1.5 mmol silver nitrate and 0.3 mmol iron sulfate in deionized water respectively and after mixed together, magnetically stirring for a few minutes to produce a bright yellow solution at room temperature.

S303). leading the 4.5 g polyvinylpyrrolidone PVP into the bright yellow solution in step S301), and stirring the mixture continuously until PVP is completely dissolved, then sealing and heating it at 160° C. for 8 hours in the high pressure reactor, to obtain a gray-green precipitate after finishing the hot water reaction;

S304). washing the gray-green precipitate obtained in step S303) several times with dilute nitric acid solution to remove the oxide layer on the surface of the nanowires; then adding ethanol to remove excess nitric acid under the action of a centrifuge and collecting the long silver nanowires by repeated filtration;

S305). covering the glass of 500 nm with the long silver nanowires obtained in step S304) and heating it at a temperature of 250° C. for 1.5 h, then solidifying it with PDMS at 80° C. for 3 h and peeling it off to obtain a silver nanowire conductive film; the resistance is controlled at 2Ω.

S4). preparing a flexible stress sensor

S401). packaging the PEDOT:PSS cotton cloth fiber layer prepared in step S1), the disordered conductive carbon cloth prepared in step S2), and the silver nanowire conductive film prepared in step S3) together to form a 1×1 cm block according to the sandwich structure; packaging the edges by using PDMS and be solidified at 80° C. for 1 h;

S402). leading wires from the PEDOT:PSS cotton cloth fiber layer and the silver nanowire conductive film respectively, to obtain a flexible stress sensor. As shown in FIG. 1, the sensor comprises the PEDOT: PSS cotton cloth fiber layer 2, disordered conductive carbon cloth 3, and silver nanowire conductive film 4 from top to bottom successively, and the disordered conductive carbon cloth 3 is provided between PEDOT: PSS cotton cloth fiber layer 1 and silver nanowire conductive film 4; the wires 2 are copper conductive tape; the sensor provided by the embodiments starts from 1.25 kPa and increasing sequentially by 1.25 kPa to 7.5 kPa, the diagram of the relationships between the resistance relative change and time of the flexible stress sensor can be shown in FIG. 5. According to the diagram, the sensor will increase in accordance with 1.25 kPa as a gradient increment with the gradual increase of the resistance relative change of the pressure; The relative change of resistance is 0.038 when is 1.25 kPa, the relative change of resistance is 0.058 when 2.5 kPa, the relative change of resistance is 0.07 when is 3.75 kPa, the relative change of resistance is 0.08 when is 5 kPa, the relative change of resistance is 0.085 when is 6.25 kPa, the relative change of resistance is 0.10 when is 7.5 kPa.

### Embodiments 3

A preparation method for a flexible stress sensor based on a composite multilayer conductive material, comprises the following steps:

S1). preparing a PEDOT: PSS cotton cloth fiber layer

S101). adding 3.5 g poly-3,4-ethoxylene dioxy thiophene monomer: polystyrene sulfonate PEDOT:PSS to the 0.35 g dimethyl sulfoxide DMSO solution for modification; heating and stirring in an oil bath at 50° C. for 1 h and dropwise adding 5 mL absolute ethyl alcohol for 2 h with the temperate 50° C. to obtain a modified PEDOT:PSS conductive solution.

S102). soaking the cotton cloth fiber sheet with the size of 1×5 cm into the modified PEDOT:PSS conductive solution in step S101), and stirring at room temperature for 4 h, and then dried at 80° C. for 2 h.

S103). repeating the step S102) for 3 times, until the modified PEDOT:PSS conductive solution evenly penetrated and firmly attached to the cotton cloth fiber plate, to obtain PEDOT: PSS conductive cotton cloth;

S104). laying the PEDOT: PSS conductive cotton cloth obtained in step S103) is on the surface of PDMS solution, to fix up and cover the one side of the conductive cotton cloth with PDMS solution, and to obtain PEDOT: PSS cotton cloth fiber layer; the resistance is controlled at 950Ω.

S2). preparing conductive carbon cloth

S201). under the condition of 50% humidity, dissolving polyacrylonitrile PAN in N—N dimethylformamide DMF solvent to configure a solution of 15 wt % concentration.

S202). stirring the solution obtained in step S201) at a constant temperature of 60° C. for 6 h to obtain a spinning solution, and to be sealed and stored for backup.

S203). to obtain the PAN fiber through spinning for 8 h by the disorder electrostatic spinning machine with the receiving distance of 10 cm and voltage 5 KV, then after the heating of 900° C. for 2 h to obtain the disorder conductive carbon cloth with the resistance control of 200Ω;

S3). preparing a metal silver nanowire conductive film

S301). dissolving 2 mmol glucose, 1.5 mmol silver nitrate and 0.3 mmol iron sulfate in deionized water respectively and after mixed together, magnetically stirring for a few minutes to produce a bright yellow solution at room temperature.

S303). leading the 4.5 g polyvinylpyrrolidone PVP into the bright yellow solution in step S301), and stirring the mixture continuously until PVP is completely dissolved, then sealing and heating it at 170° C. for 8 hours in the high pressure reactor, to obtain a gray-green precipitate after finishing the hot water reaction;

S304). washing the gray-green precipitate obtained in step S303) several times with dilute nitric acid solution to remove the oxide layer on the surface of the nanowires; then adding ethanol to remove excess nitric acid under the action of a centrifuge and collecting the long silver nanowires by repeated filtration;

S305). covering the glass of 500 nm with the long silver nanowires obtained in step S304) and heating it at a temperature of 250° C. for 1.5 h, then solidifying it with PDMS at 90° C. for 3 h and peeling it off to obtain a silver nanowire conductive film; the resistance is controlled at 2.5Ω.

S4). preparing a flexible stress sensor

S401). packaging the PEDOT:PSS cotton cloth fiber layer prepared in step S1), the disordered conductive carbon cloth prepared in step S2), and the silver nanowire conductive film prepared in step S3) together to form a 1×1 cm block according to the sandwich structure; packaging the edges by using PDMS and be solidified at 80° C. for 1 h;

S402). leading wires from the PEDOT:PSS cotton cloth fiber layer and the silver nanowire conductive film respectively, to obtain a flexible stress sensor. As shown in FIG. 1, the sensor comprises the PEDOT: PSS cotton cloth fiber layer 2, disordered conductive carbon cloth 3, and silver nanowire conductive film 4 from top to bottom successively, and the disordered conductive carbon cloth 3 is provided between PEDOT: PSS cotton cloth fiber layer 1 and silver nanowire conductive film 4; the wires 2 are copper conductive tape; the sensor provided by the embodiments starts from 1.25 kPa and increasing sequentially by 2.75 kPa to 7.5 kPa, the diagram of the relationships between the resistance relative change and time of the flexible stress sensor can be shown in FIG. 6. According to the diagram, the sensor will increase in accordance with 2.75 kPa as a gradient increment with the gradual increase of the resistance relative change of the pressure; The relative change of resistance is 0.038 when is 1.25 kPa, the relative change of resistance is 0.06 when 4 kPa, the relative change of resistance is 0.09 when is 6.75 kPa, the relative change of resistance is 0.11 when is 9.5 kPa, the relative change of resistance is 0.12 when is 12.25 kPa, the relative change of resistance is 0.14 when is 15 kPa.

### Embodiments 4

A preparation method for a flexible stress sensor based on a composite multilayer conductive material, comprises the following steps:

S1). preparing a PEDOT: PSS cotton cloth fiber layer

S101). adding 4 g poly-3,4-ethoxylene dioxy thiophene monomer: polystyrene sulfonate PEDOT:PSS to the 0.35 g dimethyl sulfoxide DMSO solution for modification; heating and stirring in an oil bath at 50° C. for 1 h and dropwise adding 5 mL absolute ethyl alcohol for 2 h with the temperate 70° C. to obtain a modified PEDOT:PSS conductive solution.

S102). soaking the cotton cloth fiber sheet with the size of 1×5 cm into the modified PEDOT:PSS conductive solution in step S101), and stirring at room temperature for 4 h, and then dried at 80° C. for 2 h.

S103). repeating the step S102) for 3 times, until the modified PEDOT:PSS conductive solution evenly penetrated and firmly attached to the cotton cloth fiber plate, to obtain PEDOT: PSS conductive cotton cloth;

S104). laying the PEDOT: PSS conductive cotton cloth obtained in step S103) is on the surface of PDMS solution, to fix up and cover the one side of the conductive cotton cloth with PDMS solution, and to obtain PEDOT: PSS cotton cloth fiber layer; the resistance is controlled at 909Ω.

S2). preparing conductive carbon cloth

S201). under the condition of 50% humidity, dissolving polyacrylonitrile PAN in N—N dimethylformamide DMF solvent to configure a solution of 15 wt % concentration.

S202). stirring the solution obtained in step S201) at a constant temperature of 60° C. for 6 h to obtain a spinning solution, and to be sealed and stored for backup.

S203). to obtain the PAN fiber through spinning for 8 h by the disorder electrostatic spinning machine with the receiving distance of 10 cm and voltage 5 KV, then after the heating of 900° C. for 2 h to obtain the disorder conductive carbon cloth with the resistance control of 200Ω;

S3). preparing a metal silver nanowire conductive film

S301). dissolving 2 mmol glucose, 1.5 mmol silver nitrate and 0.3 mmol iron sulfate in deionized water respectively and after mixed together, magnetically stirring for a few minutes to produce a bright yellow solution at room temperature.

S303). leading the 4.5 g polyvinylpyrrolidone PVP into the bright yellow solution in step S301), and stirring the mixture continuously until PVP is completely dissolved, then sealing and heating it at 170° C. for 8 hours in the high pressure reactor, to obtain a gray-green precipitate after finishing the hot water reaction;

S304). washing the gray-green precipitate obtained in step S303) several times with dilute nitric acid solution to remove the oxide layer on the surface of the nanowires; then adding ethanol to remove excess nitric acid under the action of a centrifuge and collecting the long silver nanowires by repeated filtration;

S305). covering the glass of 500 nm with the long silver nanowires obtained in step S304) and heating it at a temperature of 260° C. for 1 h, then solidifying it with PDMS at 110° C. for 3 h and peeling it off to obtain a silver nanowire conductive film; the resistance is controlled at 2.2Ω.

S4). preparing a flexible stress sensor

S401). packaging the PEDOT:PSS cotton cloth fiber layer prepared in step S1), the disordered conductive carbon cloth prepared in step S2), and the silver nanowire conductive film prepared in step S3) together to form a 1×1 cm block according to the sandwich structure; packaging the edges by using PDMS and be solidified at 80° C. for 1 h;

S402). leading wires from the PEDOT:PSS cotton cloth fiber layer and the silver nanowire conductive film respectively, to obtain a flexible stress sensor. As shown in FIG. 1, the sensor comprises the PEDOT: PSS cotton cloth fiber layer 2, disordered conductive carbon cloth 3, and silver nanowire conductive film 4 from top to bottom successively, and the disordered conductive carbon cloth 3 is provided between PEDOT: PSS cotton cloth fiber layer 1 and silver nanowire conductive film 4; the wires 2 are copper conductive tape; the sensor provided by the embodiments starts from 2.5 kPa and increasing sequentially by 2.5 kPa to 70 kPa, the diagram of the relationships between the resistance relative change and time of the flexible stress sensor can be shown in FIG. 7. According to the diagram, the sensor will increase in accordance with 2.5 kPa as a gradient increment with the gradual increase of the resistance relative change of the pressure; the connection line of the highest point shows a linear variation below 20 kPa with high sensitivity.

The invention and the embodiments thereof are described hereinabove, and this description is not restrictive. What is shown above is only the principles and the preferred embodiments of the invention, and the actual structure is not limited thereto. In summary, any equivalent structures or equivalent process transformations made by using the specifications and the attaching drawings of the invention, or direct or indirect applications to other related technical fields, shall all fall within the protection scope of the invention.

1. A preparation method for a flexible stress sensor based on a composite multilayer conductive material, wherein comprises the following steps:
S1) preparing a PEDOT: PSS cotton cloth fiber layer
S101) adding poly-3,4-ethoxylene dioxy thiophene monomer: polystyrene sulfonate PEDOT:PSS to a dimethyl sulfoxide DMSO solution for modification; heating and stirring in an oil bath at 40-60° C. for 0.5-2 h and dropwise adding absolute ethyl alcohol for 1-3 h to obtain a modified PEDOT:PSS conductive solution;
S102) soaking the cotton cloth fiber sheet with the appropriate size into the modified PEDOT:PSS conductive solution in step S101), and stirring at room temperature for 3-5 h, and then dried at 70-100° C. for 1-3 h;
S103) repeating the step S102) for 2-5 times, until the modified PEDOT:PSS conductive solution evenly penetrated and firmly attached to the cotton cloth fiber plate, to obtain PEDOT: PSS conductive cotton cloth;
S104) laying the PEDOT: PSS conductive cotton cloth obtained in step S103) is on the surface of PDMS solution, to fix up and cover the one side of the conductive cotton cloth with PDMS solution, and to obtain PEDOT: PSS cotton cloth fiber layer;
S2) preparing conductive carbon cloth
S201) under the condition of 40-60% humidity, dissolving polyacrylonitrile PAN in N—N dimethylformamide DMF solvent to configure a solution of 10-20 wt % concentration;
S202) stirring the solution obtained in step S201) at a constant temperature of 50-70° C. for 3-8 h to obtain a spinning solution, and to be sealed and stored for backup;
S203) preparing disordered conductive carbon cloth by disordered electrostatic spinning machine;
S3) preparing a metal silver nanowire conductive film
S301) dissolving a certain amount of glucose, silver nitrate and iron sulfate in deionized water respectively and after mixed together, magnetically stirring for a few minutes to produce a bright yellow solution at room temperature;
S303) leading the polyvinylpyrrolidone PVP into the bright yellow solution in step S301), and stirring the mixture continuously until PVP is completely dissolved, then sealing and heating it at 150-180° C. for 3-8 hours in the high pressure reactor, to obtain a gray-green precipitate after finishing the hot water reaction;
S304) washing the gray-green precipitate obtained in step S303) several times with dilute nitric acid solution to remove the oxide layer on the surface of the nanowires; then adding ethanol to remove excess nitric acid under the action of a centrifuge and collecting the long silver nanowires by repeated filtration;
S305) covering the glass with the long silver nanowires obtained in step S304) and heating it at a temperature of 200-300° C. for 2-3 h, then solidifying it with PDMS at 60-100° C. for 2-6 h and peeling it off to obtain a silver nanowire conductive film;
S4) preparing a flexible stress sensor
S401) packaging the PEDOT:PSS cotton cloth fiber layer prepared in step S1), the disordered conductive carbon cloth prepared in step S2), and the silver nanowire conductive film prepared in step S3) together; packaging the edges by using PDMS and be solidified at 60-100° C. for 0.5-2 h;
S402) leading wires from the PEDOT:PSS cotton cloth fiber layer and the silver nanowire conductive film respectively, to obtain a flexible stress sensor.

2. The preparation method for a flexible stress sensor based on a composite multilayer conductive material according to claim 1, wherein in step S104), the resistance of the obtained PEDOT:PSS cotton cloth fiber layer is controlled at 900-1200Ω.

3. The preparation method for a flexible stress sensor based on a composite multilayer conductive material according to claim 1, wherein in step S203), the PAN fibers are obtained by disordered electrostatic spinning machine to spin for 8-12 h with the receive distance of 10-15 cm and voltage of 3-5 KV, and then prepared by heating at the temperature of 900-1100° C. for 1-5 h to obtain disordered conductive carbon cloth.

4. The preparation method for a flexible stress sensor based on a composite multilayer conductive material according to claim 1, wherein in step S203), the resistance of the obtained disordered conductive carbon cloth is controlled at 200-300Ω.

5. The preparation method for a flexible stress sensor based on a composite multilayer conductive material according to claim 1, wherein in step S301), the glucose, silver nitrate and iron sulfate are dissolved in deionized water in a volume ratio of 2:2:1.

6. The preparation method for a flexible stress sensor based on a composite multilayer conductive material according to claim 1, wherein in step S304), the long silver nanowires have a length of 10-15 μm and a diameter of 200-300 nm.

7. The preparation method for a flexible stress sensor based on a composite multilayer conductive material according to claim 1, wherein in step S305), the resistance of the obtained silver nanowire conductive film is controlled at 0.1-3Ω.

8. The preparation method for a flexible stress sensor based on a composite multilayer conductive material according to claim 1, wherein in step S401), the PEDOT: PSS cotton cloth fiber layer, disordered conductive carbon cloth, and silver nanowire conductive film are packaged in a sandwich structure, and the disordered conductive carbon cloth is provided between the PEDOT: PSS cotton cloth fiber layer and the silver nanowire conductive film.

9. The preparation method for a flexible stress sensor based on a composite multilayer conductive material according to claim 1, wherein in step S402), the wires are copper conductive tape.
